(19) United States
(12) Patent Application Publication
(10) Pub. No.: US 2007/0171344 A1
(43) Pub. Date: Jul. 26, 2007

(54) Liquid crystal element and optical pickup device having the same

(75) Inventors: Kenji Nagashima, Osaka (JP); Mitsuyoshi Sasabe, Osaka (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/653,933

(22) Filed: Jan. 17, 2007

(30) Foreign Application Priority Data
Jan. 24, 2006 (JP) 2006-015476

(51) Int. Cl. G02F 1/1343

(52) U.S. Cl. 349/139

(57) ABSTRACT

A liquid crystal element includes a first transparent electrode (14) and a second transparent electrode (15), which have different concentric split areas (14a-14d) and (15a-15e), each of the split areas (14a-14d) of the first transparent electrode (14) faces two areas out of the split areas (15a-15e) of the second transparent electrode (15), and on the other hand, each of the split area (15a) and the split area (15e) out of the split areas (15a-15e) of the second transparent electrode (15) faces only one area, i.e., the split area (14a) and (14d) of the first transparent electrode (14), and each of the other split areas (15b-15d) faces two areas out of the split areas (14a-14d) of the first transparent electrode (14).

This application is based on Japanese Patent Application No. 2006-015476 filed on Jan. 24, 2006, the contents of which are hereby incorporated by reference.

### BACKGROUND OF THE INVENTION

1. Field of the Invention

The present invention relates to a liquid crystal element that is provided to an optical device such as an optical pickup device and the like, and in particular it relates to a liquid crystal element that enables adjustment of wave aberration. Furthermore, the present invention relates to an optical pickup device equipped with the liquid crystal element for correcting the wave aberration.

2. Description of Related Art

Recently optical recording media including a compact disc (hereinafter referred to as CD) and a digital versatile disc (hereinafter referred to as DVD) are widely available and are used commonly. In order to increase recording capacity of the optical recording medium, studies about high density recording on the optical recording medium have been proceeding. For example, high density optical recording media including an HD-DVD and a Blu-Ray Disc (hereinafter referred to as BD) that are high quality DVDs are being available.

When information is recorded or reproduced on the optical recording medium, an optical pickup device is used, which projects a light beam to the optical recording medium for writing and reading information. The optical pickup device has different values of numerical aperture (NA) of an objective lens and wavelength of a light source depending on different types of the optical recording medium. For example, the NA of the objective lens is 0.50 and the wavelength of the light source is 780 nm for a CD, the NA of the objective lens is 0.65 and the wavelength of the light source is 650 nm for a DVD, the NA of the objective lens is 0.65 and the wavelength of the light source is 405 nm for an HD-DVD, and the NA of the objective lens is 0.85 and the wavelength of the light source is 405 nm for a BD.

In this way, the NA of the objective lens and the wavelength are different in accordance with types of the optical recording medium. Although, it is considered to use different optical pickup devices for different types of the optical recording medium, it is more convenient to use a single optical pickup device that can write and read information on a plurality of types of optical recording media, and a lot of such optical pickup devices are developed. Among them, there is an optical pickup device that can write and read information on a plurality of types of optical recording media using a single objective lens as disclosed in JP-A-2005-71424, for example.

When a single objective lens supports a plurality of types of optical recording media, even correction of spherical aberration of the objective lens is performed for one type of optical recording medium, the spherical aberration may be generated when information is read or written on the other type of optical recording medium. Therefore, it is a common method as disclosed in JP-A-2005-71424 to dispose a liquid crystal panel (liquid crystal element) in the optical pickup device so that the spherical aberration is corrected by controlling voltage applied to the liquid crystal element. The liquid crystal element that is disposed for the above mentioned purpose is described in JP-A-2005-71424 and other many documents, which is a type having two transparent electrodes that constitute the liquid crystal element. One of the two transparent electrodes is divided into a plurality of concentric areas, while the other is a common electrode without being divided. Each of voltages that are applied to the divided areas of the transparent electrode is controlled for correcting the spherical aberration.

However, in order to correct appropriately the aberrations generated in laser beams for a plurality of types of optical recording media by using the above mentioned liquid crystal element, it is necessary to increase the number of division of the transparent electrode that is divided into a plurality of concentric areas. Consequently, the number of wires that are drawn out from the respective areas increases, and the area of portions of the liquid crystal element for the wires is increased, resulting in insufficient correction of the aberration. In addition, if the number of the divided concentric areas increases, the number of electrodes and wires provided to a circuit board for controlling the liquid crystal element is also increased, resulting in increases of dimensions of the optical pickup device and cost of manufacturing the device.

As to this point, it is possible to decrease the number of divisions of the transparent electrode of the divided side of the liquid crystal element by adopting a concept of performing the aberration correction not completely but approximately for a plurality of types of optical recording media. Thus, it is possible to some extent to reduce the number of the wires provided to the transparent electrode and the numbers of electrodes and wires provided to the circuit board for controlling the liquid crystal element. However, there is a limit to this reduction.

In addition, it is also considered to adopt a gradation type of liquid crystal panel or a segment type of liquid crystal panel as described in JP-A-2005-71424 for decreasing the number of wires that are drawn out from the liquid crystal panel and thus to reduce the numbers of the electrodes and wires provided to the circuit board for controlling the liquid crystal panel. The segment type of liquid crystal panel includes a plurality of concentric transparent electrodes having low resistances and resister elements made of the same material as the transparent electrode for connecting neighboring electrodes to each other. The gradation type of liquid crystal panel includes a plurality of concentric electrodes having low resistances arranged on the non-divided transparent electrode having high resistance. However, a problem is introduced that these structures of the liquid crystal panel become complicated, so manufacturing cost of the liquid crystal panel will be increased if these structures are adopted.

### SUMMARY OF THE INVENTION

In view of above, an object of the present invention is to provide a liquid crystal element having a simple structure for reducing undesired aberration that is generated due to presence of wires provided to positions overlapping a transparent electrode while securing the appropriate number of areas of the transparent electrode for correcting wave aberration appropriately. Another object of the present invention is to provide a liquid crystal element that can reduce the number of wires that are connected to a circuit board for controlling the liquid crystal panel while achieving the above mentioned object. Still another object of the present invention is to provide an optical pickup device equipped with the above mentioned liquid crystal element that enables an appropriate correction of the wave aberration as well as a small size and low manufacturing cost.

To achieve above described object, a liquid crystal element according to the present invention includes liquid crystal and two transparent electrodes including a first transparent electrode and a second transparent electrode sandwiching the liquid crystal. Each of the first transparent electrode and the second transparent electrode is divided into a plurality of split areas having different patterns. The patterns of the first and the second transparent electrodes are formed in such a manner that the number of phase shift areas that generates a phase difference in a light beam entering the liquid crystal element when a predetermined potential is applied to each of the split areas is larger than the number of the split areas in each of the first transparent electrode and the second transparent electrode.

Preferably in the liquid crystal element of the present invention having the structure described above, at least in the portion where the transparent electrode exists, at least one of wires that are drawn out from the split areas of one of the first transparent electrode and the second transparent electrode that has smaller number of the split areas is formed at a position that overlaps a wire that is drawn out from the split area of the other transparent electrode.

More preferably in the liquid crystal element of the present invention having the structure described above, the split areas formed on the first and the second transparent electrodes are a plurality of concentric areas, each of the split areas of the first transparent electrode faces one or more of the split areas of the second transparent electrode, and at least one of the split areas of the second transparent electrode faces two or more of the split areas of the first transparent electrode.

Still more preferably in the liquid crystal element of the present invention having the structure described above, one or more groups of areas out of the split areas have two or more wires that are connected electrically to be the same potential on at least one of the first transparent electrode and the second transparent electrode, and the total number of connection wires that connect the first and the second transparent electrodes to electrodes that are provided externally is less than the number of the phase shift areas.

Furthermore, an optical pickup device according to the present invention is equipped with the liquid crystal having the structure described above.

According to the first structure of the present invention, while securing the appropriate number of phase shift areas for generating phase differences in a light beam entering the liquid crystal element so that aberration can be corrected appropriately, the maximum number of wires that are drawn out from one transparent electrode can be reduced compared with a liquid crystal element having a structure in which only one transparent electrode transparent electrode is divided. As a result, the aberration that is generated due to presence of wires that are disposed on positions overlapping the transparent electrode can be reduced.

In addition, according to the second structure of the present invention, the aberration that is generated due to presence of wires can be reduced effectively in the liquid crystal element having the first structure described above.

In addition, according to the third structure of the present invention, it is possible to realize a liquid crystal element that can reduce the aberration that is generated due to presence of wires that are disposed on positions overlapping the transparent electrode with a simple structure in the first or the second structure of the liquid crystal element.

In addition, according to the fourth structure of the present invention, the number of connection wires that are drawn out from the liquid crystal element and are connected to electrodes on a circuit board for controlling voltages to be applied to the liquid crystal element is reduced in the liquid crystal element having one of the first to the third structures described above. Therefore, the number of the electrodes disposed on the circuit board and the number of the wires can be reduced.

In addition, according to the fifth structure of the present invention, the aberration that is generated due to presence of wires that are disposed on positions overlapping the transparent electrode of the liquid crystal element can be reduced in the optical pickup device equipped with the liquid crystal element having one of the first to the fourth structure described above. Thus, it is possible to provide the optical pickup device that can correct the aberration appropriately and easily. Furthermore, since the number of the wires that are drawn out from the liquid crystal element can also be reduced, the number of wires and electrodes that are disposed on the circuit board for controlling voltages to be applied to the liquid crystal element can be reduced. As a result, dimensions and manufacturing cost of the optical pickup device can be reduced.

### BRIEF DESCRIPTION OF THE DRAWINGS

FIG. 1 is a schematic diagram to show a structure of an optical system of an optical pickup device equipped with a liquid crystal element according to an embodiment of the present invention.

FIG. 2 is a schematic diagram for explaining a structure of a liquid crystal element according to the first embodiment.

FIGS. 3A and 3B are top views for explaining a structure of electrode patterns of transparent electrodes of the liquid crystal element according to the first embodiment, and FIG. 3C is a cross sectional view of the same.

FIG. 4 is a graph to show a relationship between the spherical aberration generated in the optical pickup device according to the present embodiment and a phase difference to be generated by the liquid crystal element according to the first embodiment.

FIG. 5A is a top view for explaining a structure of a conventional liquid crystal element, and FIG. 5B is a cross sectional view of the same.

FIGS. 6A and 6B are top views for explaining a structure of an electrode pattern of a transparent electrode of the liquid crystal element according to a second embodiment, and FIG. 6C shows a cross sectional view of the same.

### DESCRIPTION OF THE PREFERRED EMBODIMENTS

Now embodiments of the present invention will be explained with reference to the attached drawings. It should be noted that the embodiments described below are merely examples, and the present invention is not limited to the embodiments.

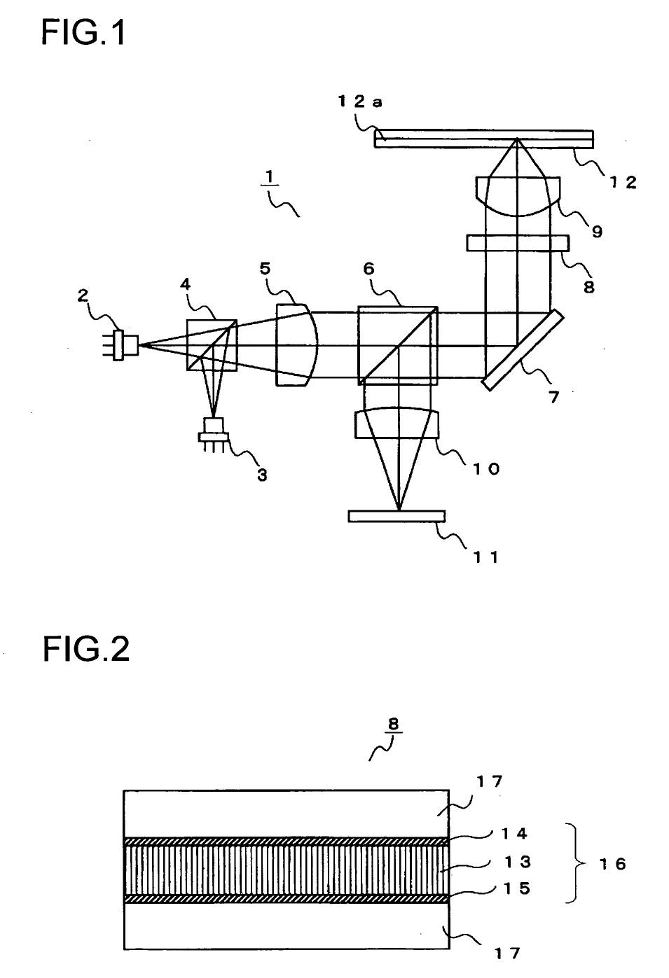

FIG. 1 is a schematic diagram to show a structure of an optical system of an optical pickup device equipped with a liquid crystal element according to an embodiment of the present invention. Reference number 1 is an optical pickup device, which can read information recorded on a recording surface 12a of an optical recording medium 12 by projecting a light beam to the optical recording medium 12 that is either of two types, i.e., a DVD and a BD and by receiving reflected light. An optical pickup device 1 can also write information on the recording surface 12a by projecting a light beam to the optical recording medium 12. It should be noted that the types and the number of the optical recording media 12 on which the optical pickup device 1 can read and write information, are not limited to the types and the number shown in this embodiment, but they can be changed variously within the scope of the present invention.

This optical pickup device 1 is equipped with a first light source 2, a second light source 3, a dichroic prism 4, a collimator lens 5, a beam splitter 6, an upstand mirror 7, a liquid crystal element 8, an objective lens 9, a detection lens 10, and a photo detector 11. Each of the optical members that constitute the optical pickup device 1 will be described in detail as follows.

The first light source 2 is a semiconductor laser that can emit a light beam with a wavelength of 650 nm band corresponding to a DVD, and the second light source 3 is a semiconductor laser that can emit a light beam with a wavelength of 405 nm band corresponding to a BD. Although a semiconductor laser that can emit a light beam with a single wavelength is used as the light sources 2 and 3 in the present embodiment, the present invention is not limited to this structure, and it is possible to use an integrated two wavelength semiconductor laser having two light emission points so that two light beams with two different wavelengths are emitted, for example.

The dichroic prism 4 permits the light beam emitted from the first light source 2 that emits a light beam for a DVD to pass, while the dichroic prism 4 reflects the light beam emitted from the second light source 3 that emits a light beam for a BD. Then, the dichroic prism 4 makes optical axes of the light beams emitted from the first light source 2 and the second light source 3 match each other. The light beam that passed through the dichroic prism 4 or was reflected by the same is sent to the collimator lens 5.

The collimator lens 5 converts the light beam that passed through the dichroic prism 4 into parallel rays. At this point the term “parallel rays” means each of the light rays included in the light which is emitted from the first light source 2 or the second light source 3, has an optical path that is substantially parallel to the optical axis. The light beam that was made to be the parallel rays by the collimator lens 5 is sent to the beam splitter 6.

The beam splitter 6 works as a light separation element that separates the incident light beam. The beam splitter 6 permits the light beam from the collimator lens 5 to pass through and leads the light beam to the optical recording medium 12, while the beam splitter 6 reflects the reflection light reflected by the optical recording medium 12 and leads the reflection light to the photo detector 11. The light beam that passed through the beam splitter 6 is sent to the upstand mirror 7.

The upstand mirror 7 reflects the light beam that passed through the beam splitter 6 and leads the same to the optical recording medium 12. The upstand mirror 7 is inclined by 45 degrees with respect to the optical axis of the light beam from the beam splitter 6, so the optical axis of the light beam reflected by the upstand mirror 7 is substantially perpendicular to the recording surface 12a of the optical recording medium 12. The light beam reflected by the upstand mirror 7 is sent to the liquid crystal element 8.

The liquid crystal element 8 is an element that enables control of a phase of the light beam that passes through the liquid crystal element 8 by controlling a change of its refractive index. This control utilizes a character of liquid crystal in which liquid crystal molecules change their orientations when voltage is applied across the transparent electrodes sandwiching the liquid crystal (not shown). By an arrangement of this liquid crystal element 8 it is enabled that the correction of the spherical aberration generated due to a variation of thickness of a protection layer for protecting the recording surface 12a of the optical recording medium 12 or other factors. In the present embodiment, it is possible to correct the spherical aberration generated in the light beam emitted from the light source for a DVD (the first light source 2). The details of the liquid crystal element 8 will be described later. The light beam that passed through the liquid crystal element 8 is sent to the objective lens 9.

The light beam that passed through the liquid crystal element 8 is condensed by the objective lens 9 on the recording surface 12a of the optical recording medium 12. The objective lens 9 in the present embodiment is designed not to generate the spherical aberration in the light beam emitted from the light source for a BD (the second light source 3). In this case, the spherical aberration is generated in the light beam that was emitted from the light source for a DVD (the first light source 2) and passes through the objective lens 9. Therefore, the above mentioned liquid crystal element 8 is disposed in the optical system of the optical pickup device 1 so that the spherical aberration can be corrected. In addition, the objective lens 9 can be driven by an objective lens actuator (not shown) to move in the vertical direction and in the horizontal direction in FIG. 1, for example. Thus, a position of the objective lens 9 is controlled in accordance with a focus servo signal and a tracking servo signal.

At this point the liquid crystal element 8 is also mounted on the objective lens actuator so that the liquid crystal element 8 can be moved together with the objective lens 9 in the present embodiment. However, it is not always necessary to mount the liquid crystal element 8 on the objective lens actuator, but the structure thereof can be modified in accordance with the structure of the optical system.

The reflection light reflected by the optical recording medium 12 passes through the objective lens 9 and the liquid crystal element 8 in this order, and the light is reflected by the upstand mirror 7. After that, the light is further reflected by the beam splitter 6, and the detection lens 10 condenses the light on a light receiving portion (not shown) provided to the photo detector 11.

The photo detector 11 converts the received light signal into an electric signal, which is output to an RF amplifier (not shown) or the like, for example. Then, this electric signal is used as a reproduced signal of data recorded on the recording surface 12a and further used as a servo signal for performing a focus control and a tracking control.

Next, a first embodiment of structure of the liquid crystal element 8 provided to the optical pickup device 1 according to the present embodiment will be described. FIG. 2 is a schematic diagram for explaining a structure of the liquid crystal element 8 of the first embodiment provided to the optical pickup device 1. As shown in FIG. 2, the liquid crystal element 8 includes a liquid crystal 13, two transparent electrodes 14 and 15 (a first transparent electrode 14 and a second transparent electrode 15) sandwiching the liquid crystal 13, two glass plates 17 sandwiching a portion 16 made up of the liquid crystal 13, and the transparent electrodes 14 and 15.

The liquid crystal 13 has a character in which liquid crystal molecules inside change their orientations when voltage is applied across both ends resulting in a change of its refractive index. Therefore, a change of an optical path difference is generated for the light beam that passes through the liquid crystal in accordance with the change of the refractive index of the liquid crystal 13. Thus, a phase difference corresponding to the change of the optical path difference is generated. The transparent electrodes 14 and 15 are made of an ITO or the like having light transmission property. In addition, the transparent electrodes 14 and 15 are formed and retained on the glass substrate 17. At this point wires are drawn out from the transparent electrodes 14 and 15 as will be described later. The wires are electrically connected to electrodes that are disposed on a circuit board (not shown) for controlling voltages that are applied to the liquid crystal element 8 (hereinafter, this controlling circuit board may be referred to as circuit board, simply).

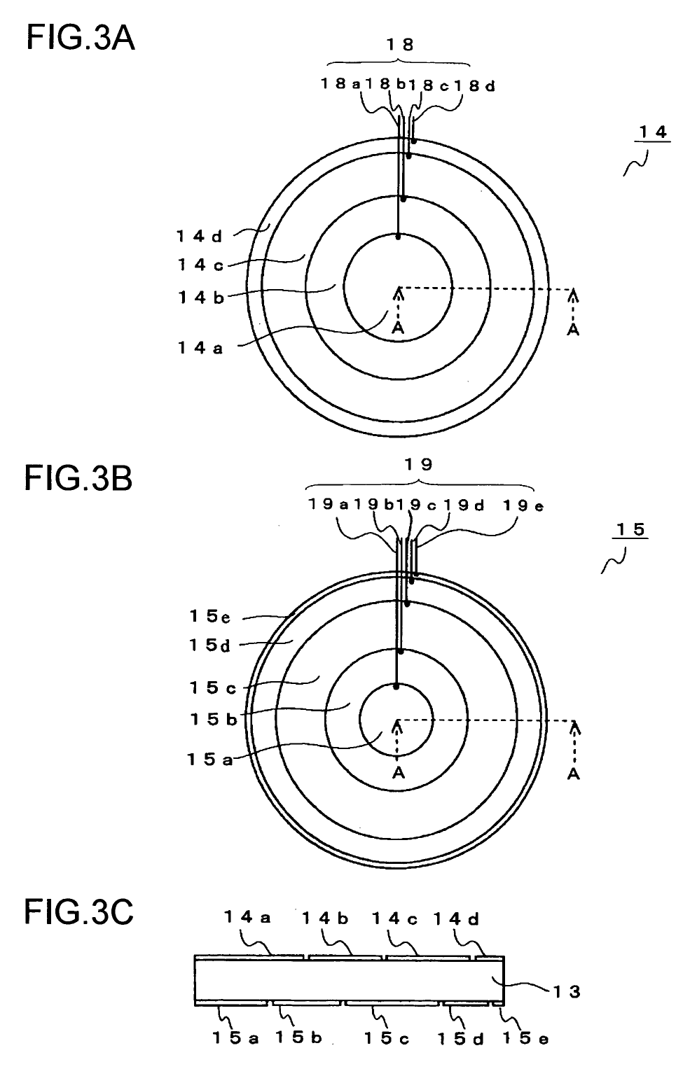

FIGS. 3A-3C are diagrams for explaining a structure of electrode patterns of the first transparent electrode 14 and the second transparent electrode 15 provided to the liquid crystal element 8. FIGS. 3A and 3B are top views to show the electrode patterns of the first transparent electrode 14 and the second transparent electrode 15, and FIG. 3C is a diagram to show a relationship between the patterned positions of the first transparent electrode 14 and the second transparent electrode 15, which is a cross sectional view when cut along the line A-A in FIGS. 3A and 3B.

As shown in FIGS. 3A-3C, the first transparent electrode 14 of the liquid crystal element 8 is divided into four concentric split areas 14a-14d, while the second transparent electrode 15 is divided into five concentric split areas 15a-15e. As shown in FIG. 3C, each of the split areas 14a-14d of the first transparent electrode 14 faces two areas out of the split areas 15a-15e of the second transparent electrode 15. On the other hand, each of the split area 15a and the split area 15e out of the split areas 15a-15e of the second transparent electrode 15 faces a single area of the split area 14a or 14d of the first transparent electrode 14. Each of the other split areas 15b-15d faces two areas out of the split areas 14a-14d of the first transparent electrode 14.

By this arrangement, when predetermined potentials (V14a, V14b, V14c, V14d, V15a, V15b, V15c, V15d, and V15e) are applied to the split areas 14a-14d of the first transparent electrode 14 and to the split areas 15a-15e of the second transparent electrode 15 respectively, eight phase shift areas are generated in the liquid crystal 13 of the liquid crystal element 8. The eight phase shift areas are defined by eight applied voltages that are calculated by V14a-V15a, V14a-V15b, V14b-V15b, V14b-V15c, V14c-V15c, V14c-V15d, V14d-V15d, and V14d-V15e, respectively. In other words, it is possible to form the phase shift areas for generating the phase difference for the light beam that enters the liquid crystal element 8 in the number more than the number of split areas formed by dividing the first transparent electrode 14 and the second transparent electrode 15 (four and five areas, respectively).

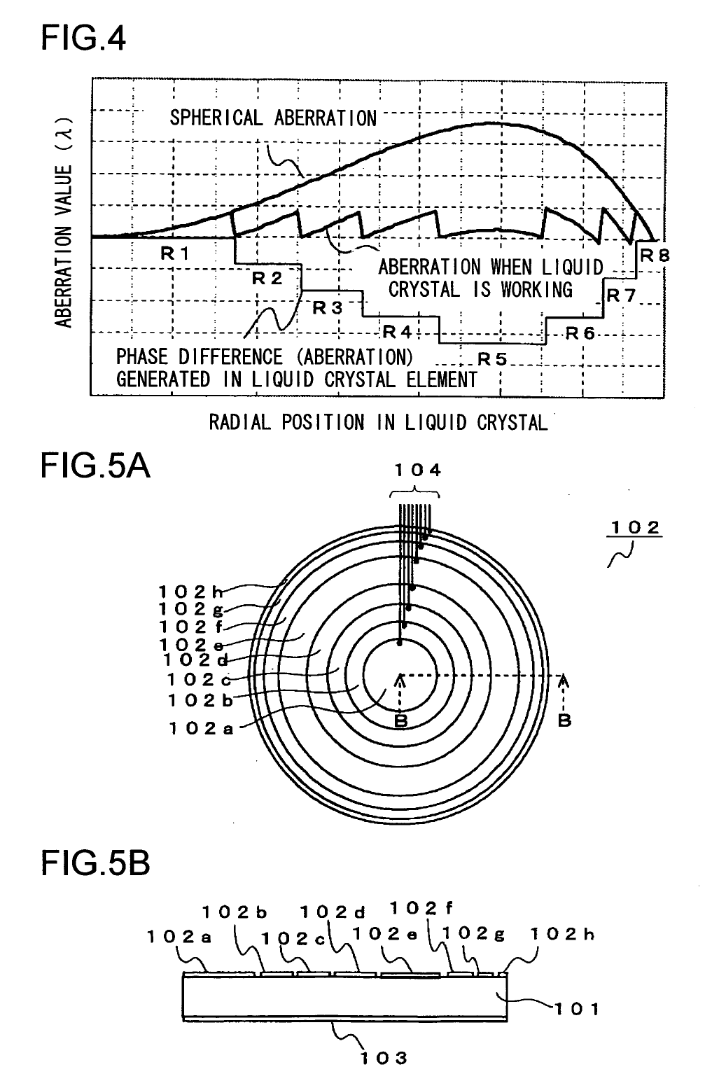

An action of this structure of the liquid crystal element 8 will be described with reference to FIG. 4. At this point FIG. 4 is a graph to show a relationship between the spherical aberration generated in the light beam emitted from the light source for a DVD (the first light source 2) and a phase difference to be generated by the liquid crystal element 8 for correcting the spherical aberration. In FIG. 4 that shows graphs of phase differences generated in the liquid crystal element, R1-R8 corresponds in this order to the eight areas to which the above mentioned voltages are applied that are calculated as differences between potentials applied to split areas of the first transparent electrode 14 and the second transparent electrode 15. In each of the areas R1-R8, a predetermined phase difference is generated by applying voltage to the liquid crystal 13. Thus, the spherical aberration generated in the light beam for a DVD is corrected to be reduced to a level that can be neglected as to quality (corresponding to “aberration when liquid crystal is working” in FIG. 4) when information is recorded or reproduced on a DVD by using the optical pickup device 1.

FIGS. 5A and 5B show an example of a structure of a conventional liquid crystal element, which is used for a comparison with the liquid crystal element 8 of the present embodiment. FIG. 5A is a top view to show an electrode pattern of a first transparent electrode 102, and FIG. 5B is a cross sectional view when cut along the line B-B in FIG. 5A. At this point a structure of a second transparent electrode 103 out of the two transparent electrodes 102 and 103 is not shown in FIGS. 5A and 5B because the second transparent electrode 103 has a single common electrode as a whole surface without forming any electrode pattern. In addition, reference number 101 is liquid crystal in FIGS. 5A and 5B.

As shown in FIGS. 5A and 5B, as to the conventional liquid crystal element, if eight phase shift areas are necessary for generating phase differences for the light beam that enters the liquid crystal element so as to correct the spherical aberration for example, only the first transparent electrode 102 is divided into eight areas 102a-102h. In this case, eight wires 104 that are drawing out from the eight split areas 102a-102h of the first transparent electrode 102 are arranged on positions overlapping the first transparent electrode 102. As a result, the aberration that is generated in the portion of the wires 104 is increased.

On the other hand, as to the liquid crystal element 8 of the present embodiment shown in FIGS. 3A-3C, even if eight phase shift areas are necessary for correcting the spherical aberration as described above, the number of the split areas in each of the first and the second transparent electrodes 14 and 15 is smaller than eight. The number of wires 18 that are drawn out from the first transparent electrode 14 is four, while the number of wires 19 that are drawn out from the second transparent electrode 15 is five. Furthermore, as to the liquid crystal element 8 of the present embodiment, the positions of wires 18a-18d that are drawn out from the split areas 14a-14d of the first transparent electrode 14 are located on the positions facing the positions of wires 19a-19d that are drawn out from the split areas 15a-15e of the second transparent electrode 15 respectively via the liquid crystal 13. Therefore, the width of the portion where wires 18 and 19 that are disposed at the positions overlapping the transparent electrodes 14 and 15 overlap the transparent electrode is reduced compared with the conventional structure. As a result, quantity of the aberration generated due to presence of the wires 18 and 19 disposed at the position overlapping the transparent electrodes 14 and 15 can be reduced compared with the conventional structure.

Although all the wires 18a-18d that are drawn out from the first transparent electrode 14 overlap each other with the wires 19 that are drawn out from the second transparent electrode 15 via the liquid crystal 13 in the present embodiment. But it is possible to modify this structure within the scope of the present invention without being limited to this structure. For example, it is possible to make a structure in which only some of the wires 18 coincide with the wires 19 within a range in which the width of the portions where wires 18 and 19 overlap the transparent electrodes 14 and 15, is reduced compared with the conventional structure.

In addition, as the liquid crystal element 8 of the first embodiment, the total number of connection wires that connect the liquid crystal element 8 to the electrodes provided to the circuit board for controlling the voltages to be applied to the liquid crystal element 8 is nine that is a sum of the four wires 18 that are drawn out from the first transparent electrode 14 and five wires 19 that are drawn out from the second transparent electrode 15. The number of connection wires is the same as the sum of eight wires 104 that are drawn out from the first transparent electrode 102 and one wire that is drawn out from the second transparent electrode 103 that is the common electrode of the conventional liquid crystal element shown in FIGS. 5A and 5B. In this case, the number of electrodes disposed on the circuit board for controlling the voltages to be applied to the liquid crystal element 8 and the number of the wires cannot be reduced compared with the conventional structure. Therefore, it is difficult to downsize the circuit board if the liquid crystal element 8 of the first embodiment is used. A liquid crystal element 8 of a second embodiment in which the downsizing of the circuit board is considered, will be described below. At this point the same elements as those in the liquid crystal element 8 of the first embodiment are denoted by the same numerals, and descriptions for them will be omitted except for the case where the description is necessary in particular.

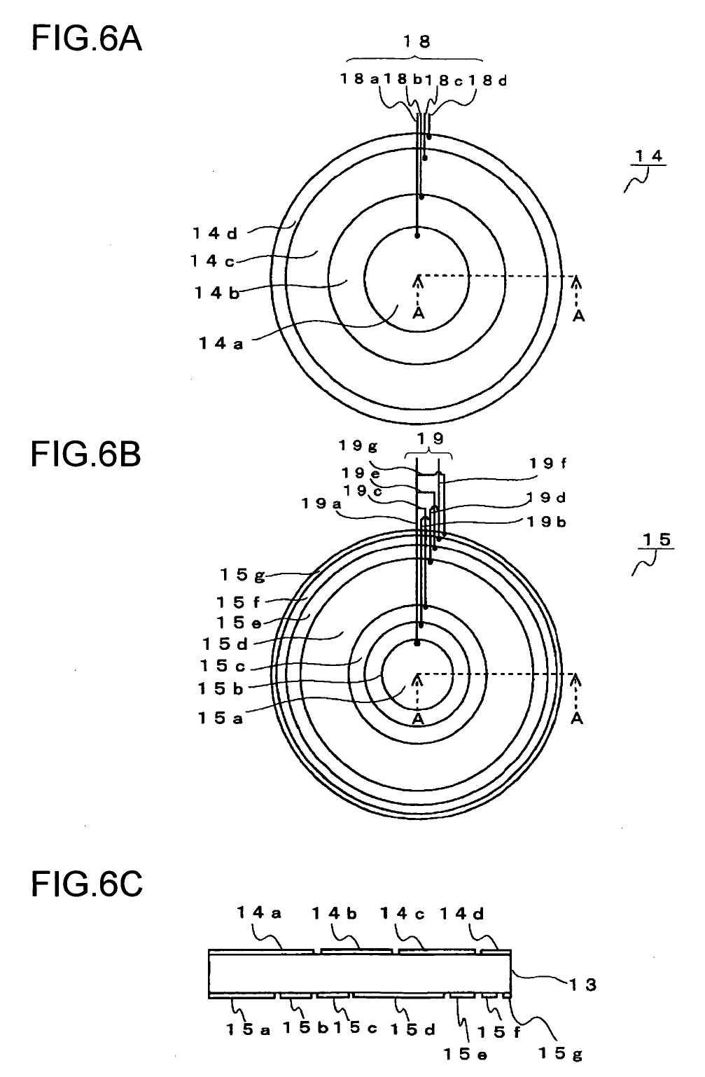

FIGS. 6A-6C are diagrams to show a structure of electrode patterns of the first transparent electrode 14 and the second transparent electrode 15 provided to the liquid crystal element 8 of the second embodiment. FIGS. 6A and 6B are top views to show electrode patterns of the first transparent electrode 14 and the second transparent electrode 15, respectively. FIG. 6C is a diagram to show a relationship between the patterned positions of the first transparent electrode 14 and the second transparent electrode 15, which is a cross sectional view when cut along the line A-A in FIGS. 6A and 6B.

Similarly to the liquid crystal element 8 of the first embodiment, the liquid crystal element 8 of the second embodiment also includes the liquid crystal 13, the transparent electrodes 14 and 15 (the first transparent electrode 14 and the second transparent electrode 15), and the glass plates 17 (see FIG. 2). However, the structure of the transparent electrodes 14 and 15 as well as a structure of the wires 18 and 19 are different from those of the first embodiment.

As shown in FIG. 6A, the first transparent electrode 14 is divided into four concentric split areas 14a-14d, while the second transparent electrode 15 is divided into seven concentric split areas 15a-15g. Further, as shown in FIG. 6C, each of the split areas 14a-14d of the first transparent electrode 14 faces two areas out of the split areas 15a-15g of the second transparent electrode 15. On the other hand, only the split area 15d out of the split areas 15a-15g of the second transparent electrode 15 faces two areas, i.e., the split areas 14b and 14c of the first transparent electrode 14, and each of the other split areas 15a-15c and 15e-15g faces only one area out of the split areas 14a-14d of the first transparent electrode 14.

If the transparent electrodes 14 and 15 are formed in this way, in the same manner as the liquid crystal element 8 of the first embodiment, there are eight phase shift areas for generating phase differences for the light beam for a DVD that enters the liquid crystal element 8 when predetermined potentials are applied to the split areas 14a-14d and 15a-15g of the transparent electrodes 14 and 15. Thus, the liquid crystal element 8 can correct the spherical aberration appropriately.

The liquid crystal element 8 of the second embodiment has seven split areas 15a-15g in the second transparent electrode 15, that are more than those in the first embodiment. However, even in this case too, the maximum number of wires that are drawn out from one transparent electrode (corresponding to seven that is the number of wires 19 that are drawn out from the second transparent electrode 15) is smaller than that in the conventional structure on which only one transparent electrode is divided (see FIG. 4). As a result, the width of the portions where wires 18 and 19 overlap the transparent electrodes 14 and 15 is reduced compared with the conventional structure. Thus, generation of the aberration due to presence of the wires 18 and 19 can be reduced.

The liquid crystal element 8 in the second embodiment has more split areas of the second transparent electrode 15 than in the first embodiment, so that the spherical aberration can be corrected in the state where the split areas 15a-15g of the second transparent electrode 15 to which different potentials are applied, are divided into two types of groups. At this point, the two types of groups include a first group consisting of the split areas 15a, 15c, 15e, and 15g, and a second group consisting of the split areas 15b, 15d, and 15f. As to the first group, the wires 19a, 19c, 19e, and 19g that are drawn out from the split areas 15a, 15c, 15e, and 15g are connected electrically to each other. As to the second group, the wires 19b, 19d, and 19f that are drawn out from the split areas 15b, 15d, and 15f are connected electrically to each other. Thus, the areas that constitute each group have the same potential.

In this case, the wires 19a, 19c, 19e, and 19g, as well as the wires 19b, 19d, and 19f are combined to only one wire finally so as to be connected to an electrode on the circuit board for controlling the liquid crystal element 8. Therefore, the number of the connection wires that connect the first transparent electrode 14 and the second transparent electrode 15 of the liquid crystal element 8 to the electrodes disposed on the circuit board becomes six that is a sum of the four wires 18 that are drawn out from the split areas 14a-14d of the transparent electrode 14 and the two wires that are drawn out from the split areas 15a-15g of the second transparent electrode 15 and are combined. This number is smaller than the total number nine of the connection wires in the case of the liquid crystal element of the conventional structure described above. Therefore, the electrodes disposed on the circuit board and wires can be reduced compared with the case where the conventional liquid crystal element is used. Thus, the circuit substrate can be downsized, and the optical pickup device 1 can also be downsized.

Although the total number of the connection wires between the transparent electrodes 14 and 15 and the electrodes disposed on the circuit substrate is reduced compared with the case of the conventional liquid crystal element by dividing the split areas 15a-15g of the second transparent electrode 15 into two types of groups to which different potentials are applied in the liquid crystal element 8 of the second embodiment, this structure can be modified within the scope of the present invention without being limited to this structure. In the case of the conventional structure, only one transparent electrode is divided into the split number of areas so that phase shift areas of the split number are obtained. In this case, the total number of the connection wires becomes the number of phase shift areas plus one (the plus one corresponds to the wire drawn out from the other transparent electrode that has a single common electrode). Therefore, it is preferable that the number of connection wires for connecting to the electrodes on the circuit board can be reduced from the above mentioned number. For example, it is possible to make three or four types of groups to which different potentials are applied by connecting the wires that are drawn out from the split areas 15a-15g of the second transparent electrode 15. In addition, it is possible to connect some of the wires 18 electrically not only for the second transparent electrode 15 but also for the first transparent electrode 15.

In addition, the structure of the electrode patterns of the transparent electrodes 14 and 15 of the liquid crystal element 8 is not limited to the structure of this embodiment described above, but it can be modified variously within the scope of the object of the present invention. For example, it is possible that some of the split areas of the first transparent electrode 14 face one or three or more split areas of the second transparent electrode 15. It is also possible that some of the split areas of the second transparent electrode face three or more split areas of the first transparent electrode.

Further, although the number of phase shift areas is eight in the embodiments described above, the number of phase shift areas can be modified variously within the range that enables the correction of the spherical aberration and satisfies requirements of device dimensions and manufacturing cost without being limited to the number eight.

Further, although the liquid crystal element 8 is used for the purpose of correcting the spherical aberration that is generated in the light beam for a DVD in the embodiments described above, the liquid crystal element 8 of the present invention can be used also as a liquid crystal element for correcting the spherical aberration that is generated when various optical recording media other than a DVD are read. In addition, the liquid crystal element can be used as a liquid crystal element for correcting other wave aberration without being limited to the spherical aberration. Furthermore, the liquid crystal element can be used not only for an optical pickup device but also for other optical devices that need correction of the aberration.

If the liquid crystal element of the present invention is used, undesired aberration that is generated due to presence of wires disposed at the position overlapping the transparent electrode of the liquid crystal element can be reduced. Therefore, it is easy to correct the aberration appropriately. In addition, the number of the wires that are drawn out from the liquid crystal element can be reduced by devising the structure of the electrode pattern while realizing the structure for correcting the aberration appropriately.

Further, if the liquid crystal element of the present invention is provided to the optical pickup device, the spherical aberration that is generated due to a variation of thickness of a substrate of an optical recording medium can be corrected appropriately, for example. In addition, since the number of electrodes disposed on the circuit board for controlling the liquid crystal panel provided to the optical pickup device and the number of the wires can be reduced, dimensions and manufacturing cost of the optical pickup device can be reduced.

What is claimed is:

1. A liquid crystal element comprising liquid crystal and two transparent electrodes including a first transparent electrode and a second transparent electrode sandwiching the liquid crystal, wherein
each of the first transparent electrode and the second transparent electrode is divided into a plurality of split areas having different patterns, and
the patterns of the first and the second transparent electrodes are formed in such a manner that the number of phase shift areas that generates a phase difference in a light beam entering the liquid crystal element when predetermined potentials are respectively applied to the split areas is larger than the number of the split areas in each of the first transparent electrode and the second transparent electrode.

2. The liquid crystal element according to claim 1, wherein at least in the portion where the transparent electrode exists, at least one of wires that are drawn out from the split areas of one of the first transparent electrode and the second transparent electrode that has smaller number of the split areas is formed at a position that overlaps a wire that is drawn out from the split area of the other transparent electrode.

3. The liquid crystal element according to claim 1, wherein the split areas formed on the first and the second transparent electrodes are a plurality of concentric areas, each of the split areas of the first transparent electrode faces one or more of the split areas of the second transparent electrode, and at least one of the split areas of the second transparent electrode faces two or more of the split areas of the first transparent electrode.

4. The liquid crystal element according to claim 1, wherein one or more groups of areas out of the split areas have two or more wires that are connected electrically to be the same potential on at least one of the first transparent electrode and the second transparent electrode, and the total number of connection wires that connect the first and the second transparent electrodes to electrodes that are provided externally is less than the number of the phase shift areas.

5. An optical pickup device that is equipped with the liquid crystal element according to claim 1.

6. The liquid crystal element according to claim 2, wherein the split areas formed on the first and the second transparent electrodes are a plurality of concentric areas, each of the split areas of the first transparent electrode faces one or more of the split areas of the second transparent electrode, and at least one of the split areas of the second transparent electrode faces two or more of the split areas of the first transparent electrode.

7. The liquid crystal element according to claim 2, wherein one or more groups of areas out of the split areas have two or more wires that are connected electrically to be the same potential on at least one of the first transparent electrode and the second transparent electrode, and the total number of connection wires that connect the first and the second transparent electrodes to electrodes that are provided externally is less than the number of the phase shift areas.

8. An optical pickup device that is equipped with the liquid crystal element according to claim 2.

9. The liquid crystal element according to claim 3, wherein one or more groups of areas out of the split areas have two or more wires that are connected electrically to be the same potential on at least one of the first transparent electrode and the second transparent electrode, and the total number of connection wires that connect the first and the second transparent electrodes to electrodes that are provided externally is less than the number of the phase shift areas.
